(19) United States
(12) Patent Application Publication
(10) Pub. No.: US 2008/0063022 A1
(43) Pub. Date: Mar. 13, 2008

(54) Semiconductor laser and tunable fluid lenses

(76) Inventors: Kevin Thomas Gahagan, Painted Post, NY (US); Jacques Gollier, Painted Post, NY (US); James Scott Sutherland, Corning, NY (US)

Correspondence Address: CORNING INCORPORATED, SP-TI-3-1, CORNING, NY, 14831, US

(21) Appl. No.: 11/519,669

(22) Filed: Sep. 12, 2006

(51) Int. Cl. H01S 3/08

(52) U.S. Cl. 372/101

(57) ABSTRACT

According to one aspect of the present invention, a semiconductor laser comprising a laser chip, a light wavelength conversion device, and a tunable lens according to the present invention is provided. The tunable lens comprises first and second fluid lens components positioned to direct light from the laser chip to the light wavelength conversion device. The first and second fluid lens components are oriented and configured such that the first and second longitudinal tuning axes defined by the lens components are skewed relative to each other and such that the respective curvatures of the lens surfaces of each lens component are variable. In accordance with another embodiment of the present invention, a tunable lens is provided comprising the first and second fluid lens components. Additional embodiments are disclosed.

### BACKGROUND OF THE INVENTION

The present invention relates to tunable fluid lenses and semiconductor lasers incorporating tunable lenses. The present invention also relates more generally to the provision of tunable fluid lenses in opto-mechanical packages.

### SUMMARY OF THE INVENTION

A single-wavelength semiconductor laser, such as a distributed-feedback (DFB) laser or a distributed-Bragg-reflector (DBR) laser, can be combined with a light wavelength conversion device, such as a second-harmonic-generation (SHG) crystal, to create a short wavelength source. More specifically, the SHG crystal can be configured to generate higher harmonic waves of the fundamental laser signal by tuning, for example, a 1060 nm DBR or DFB laser to the spectral center of a SHG crystal, which converts the wavelength to 530 nm.

According to one aspect of the present invention, a semiconductor laser comprising a laser chip, a light wavelength conversion device, and a tunable lens according to the present invention is provided. The tunable lens comprises first and second fluid lens components positioned to direct light from the laser chip to the light wavelength conversion device.

In accordance with one embodiment of the present invention, a semiconductor laser is provided comprising a laser chip, a light wavelength conversion device, and a tunable lens. The tunable lens comprises first and second fluid lens components positioned to direct light from the laser chip to the light wavelength conversion device. The first and second fluid lens components are oriented and configured such that the first and second longitudinal tuning axes defined by the lens components are skewed relative to each other and such that the respective curvatures of the convex lens surfaces of each lens component are variable.

The first lens fluid may comprise an electrically responsive lens fluid and the first and second fluid lens components may further comprise first and second sets of control electrodes oriented substantially parallel to the first longitudinal tuning axis of the tunable lens and positioned to generate an electric field capable of altering the curvature of the first convex lens surface. Alternatively, or additionally, the first and second lens fluids may comprise pressure sensitive lens fluids and the respective lens components may further comprises a fluid supply configured to alter the curvature of the first convex lens surface.

In accordance with another embodiment of the present invention, a tunable lens is provided comprising first and second fluid lens components described herein.

Accordingly, it is an object of the present invention to provide improved designs for tunable fluid lenses and improved semiconductor lasers and other types of opto-mechanical packages incorporating such lenses. Other objects of the present invention will be apparent in light of the description of the invention embodied herein.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1 is a schematic illustration of a DFB or similar type semiconductor laser incorporating a tunable fluid lens according to the present invention;

FIG. 2 is an illustration of a tunable fluid lens according to one embodiment of the present invention; and

FIGS. 3 and 4 are illustrations of a tunable fluid lens according to an alternative embodiment of the present invention.

### DETAILED DESCRIPTION

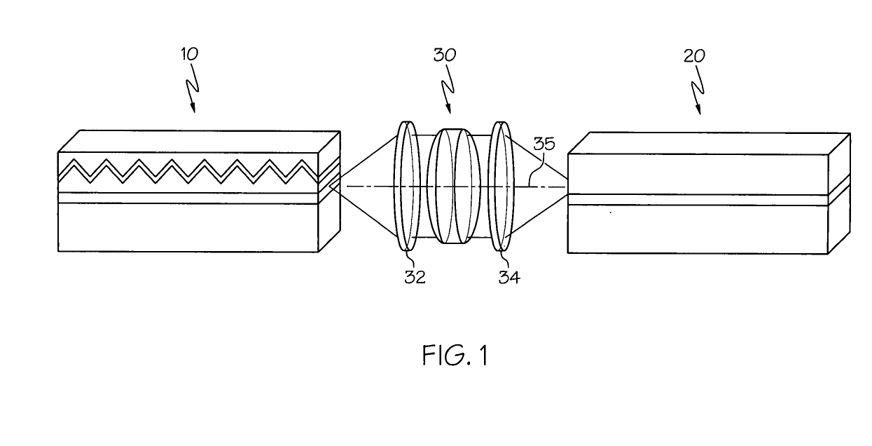

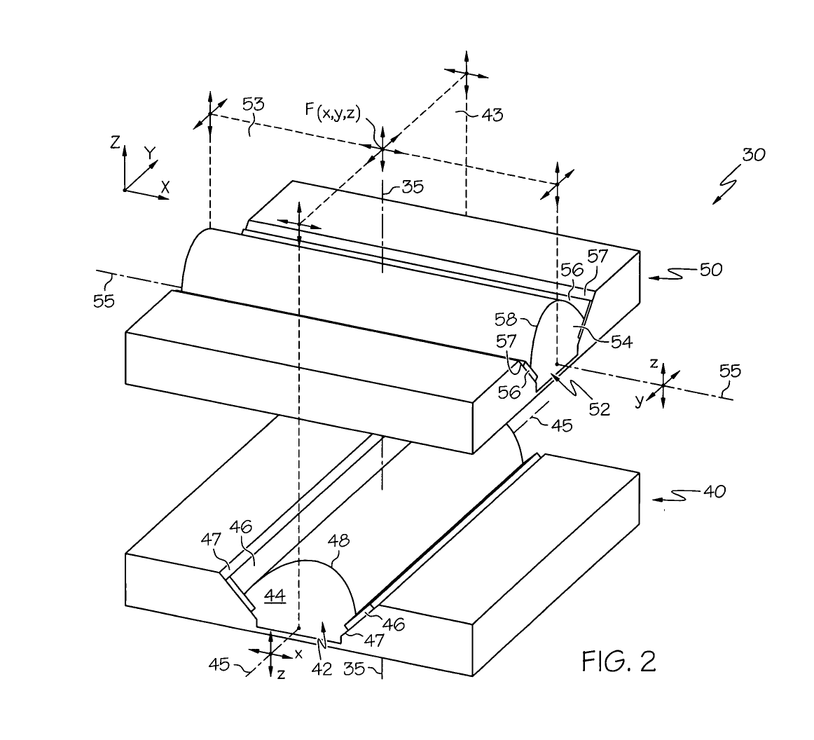

Referring initially to FIG. 1, a semiconductor laser according to one embodiment of the present invention is illustrated schematically. More specifically, the semiconductor laser comprises a laser chip 10, a light wavelength conversion device 20, and a tunable lens 30, each of which is illustrated utilizing respective symbols, as opposed to precise structural representations. FIG. 2 presents a more detailed structural illustration of a tunable lens according to a specific embodiment of the present invention. The particular structure of the laser chip 10 and the light wavelength conversion device 20 is beyond the scope of the present invention. For the purposes of describing the present invention, it is noted that the semiconductor laser 10 and light wavelength conversion device 20, when recited as components of the present invention, may embody any of a variety of conventional or yet to be developed configurations.

Tunable lenses according to the present invention have particular utility in opto-mechanical packages because it is typically difficult to ensure proper mechanical alignment of the optical components in such packages. For example, in the context of a semiconductor laser comprising a laser chip 10 and a light wavelength conversion device 20, the present inventors have recognized that it is often necessary to align optical components with sub-micron tolerances. By way of illustration, and not limitation, it is noted that additional opto-mechanical packages contemplated by the present invention include second harmonic generation laser packages, pump laser packages, and other optical packages where a single or multimode optical signal is transmitted between optical waveguides, optical fibers, optical crystals, or various combinations of active or passive optical components.

Referring to FIG. 1, a tunable lens 30 can be positioned to direct light from the laser chip 10 to the light wavelength conversion device 20. As is illustrated in FIG. 2, the tunable lens 30 comprises first and second fluid lens components 40, 50 providing first and second longitudinal tuning axes 45, 55. The first and second longitudinal tuning axes 45, 55 are skewed relative to each other about an axis of optical propagation 35 of the lens 30. In the illustrated embodiment, the axes 45, 55 are skewed relative to each other by 90 degrees, although a variety of angles of orientation relative to the axis of optical propagation are contemplated by the present invention. As will be described in further detail below, the first and second fluid lens components 40, 50 are configured such that the position of the first longitudinal tuning axis 45 can be varied in x and z components of an X-Y-Z reference frame, while the position of the second longitudinal tuning axis 55 can be varied in y and z components of the X-Y-Z reference.

As is illustrated in FIG. 1, light is directed from the laser chip 10 to the light wavelength conversion device 20 generally along the axis of optical propagation 35 of the lens 30 with the exception of relatively minor directional changes in the optical path within and between the optical components of the lens 30 itself. The tunable lens may further comprise collimating optics 32, 34 configured such that light directed from the laser chip 10 to the tunable lens 30 and from the tunable lens 30 to the wavelength conversion device 20 is substantially collimated. Because the light directed to the tunable lens 30 is collimated, those practicing this aspect of the present invention will encounter less stringent requirements in positioning the tunable lens along the axis of optical propagation 35. Further, the collimating optics 32, 34 can be introduced to alleviate optical power demands that would otherwise fall on the tunable lens 30. Specifically, the collimating optics 32, 34 can be configured to function primarily as the first order optical components of the system while the tunable lens 30 can be designed to function primarily as a second order correction system.

Referring further to FIG. 2, the above-noted positional variation of the first and second longitudinal tuning axes 45, 55 is enabled by the provision of first and second fluid reservoirs 42, 52 and first and second lens fluids 44, 54 in the first and second lens components 40, 50. In the illustrated embodiment, the first and second lens fluids 44, 54 are positioned in a generally longitudinal configuration along the respective longitudinal tuning axes 45, 55. More specifically, the fluid reservoirs 42, 52 are configured such that the lens surfaces 48, 58 formed by each lens fluid 44, 54 extend away from the axis of optical propagation 35 along the respective longitudinal tuning axes 45, 55. In contrast, many conventional liquid lenses are configured as radially symmetric lenses and do not define longitudinal tuning axes.

The first and second lens fluids 44, 54 are electrically responsive and the lens components 40, 50 comprise first and second sets of control electrodes 46, 56 configured to generate an electric field capable of altering the curvature of the first and second convex lens surfaces 48, 58 provided by the fluid within the respective fluid reservoirs 42, 52. For the purposes of describing and defining the present invention, it is noted that a fluid that is “electrically responsive” may be an electrically conductive fluid, a polar fluid of limited conductivity, or any fluid that can be arranged to physically respond to the application of an electric field thereto, in the manner described herein. Each set of control electrodes 46, 56 may preferably comprise independently controllable electrodes to maximize operational versatility.

In the illustrated embodiment, the first and second fluid reservoirs 42, 52 each comprise a pair of longitudinal container walls 47, 57 disposed on opposite sides of intersecting planes 43, 53 that pass through the longitudinal tuning axes 45, 55 of each lens component 40, 50, parallel to the axis of optical propagation 35. The first and second sets of control electrodes 46, 56 are disposed along or extend generally parallel to the corresponding pairs of longitudinal container walls 47, 57.

The first fluid reservoir 42, the first electrically responsive lens fluid 44, and the first set of control electrodes 46 are configured such that a degree of symmetry of the first lens surface 48, relative to the intersecting plane 43, is a function of a control voltage applied to the first set of control electrodes 46. Similarly, the second fluid reservoir 52, the second electrically responsive lens fluid 54, and the second set of control electrodes 56 are configured such that a degree of symmetry of the second lens surface 58, relative to the intersecting plane 53, is a function of a control voltage applied to the second set of control electrodes 46. With the control electrodes 46, 56 in an unbiased state, the convex lens surfaces 48, 58 have a substantially cylindrical profile. When the control electrodes 46, 56 are biased to generate an electric field that alters the curvature of the convex lens surfaces 48, 58, the convex lens surfaces 48, 58 assume a skewed cylindrical profile. As is noted below, the lens components may be configured such that one or both of the lens surfaces 48, 58 alternatively define a concave lens surface having a substantially cylindrical or skewed cylindrical profile.

For the purposes of describing and defining the present invention, it is noted that the phrase “substantially cylindrical” it utilized herein to describe the general longitudinal orientation of the convex lens surfaces 48, 58. The phrase is also utilized to describe the lens surfaces 48, 58 because each embodies a curved cross-sectional profile that generally corresponds to a portion of a cylinder having a major longitudinal axis that extends in the direction of the first and second longitudinal tuning axes 45, 55 of each lens component 40, 50. Although the lens surfaces 48, 58 illustrated in FIG. 2 are presented as portions of a cylinder having a circular cross section, it is noted that in practice the lens surfaces 48, 58 will often vary from the uniform radial surfaces illustrated in FIG. 2. For example, the substantially cylindrical profile of the convex lens surfaces 48, 58 may more closely approximate an elliptical cylinder or other non-circular cylinder and may include flat or nearly flat surface portions in their respective cross sections. Further, although the present invention is primarily described herein with reference to convex lens surfaces of generally longitudinal configuration, it is noted that either or both of the respective lens fluids 44, 54 may be provided to form a substantially cylindrical, concave lens surface of generally longitudinal configuration. It is also contemplated that either or both of the respective lens fluids 44, 54 may be provided to form a flat or nearly flat lens surface 48, 58. This alternative may be particularly attractive where the respective sets of control electrodes 46, 56 are controlled to merely alter the angle of the flat surfaces, relative to the axis of optical propagation 35, e.g., where the tunable lens 30 is to be used to approximate or function as an optical prism.

As is further illustrated in FIG. 2, the focal point F of the tunable lens 30 is defined by a projected intersection of the skewed longitudinal tuning axes 45, 55 in the focal plane of the tunable lens 30. The x, y, and z components defining the position of the focal point F can be controlled by varying the respective curvatures of the respective convex lens surfaces 48, 58. The particular phenomena controlling the manner in which the electric field generated by the control electrodes can be used to alter the curvature of the convex lens surfaces 48, 58 is beyond the scope of the present invention and may be discerned from a variety of readily available teachings on the subject. For example, and not by way of limitation, U.S. Pat. Nos. 6,538,823, 6,778,328, and 6,936,809 provide specific instruction on the subject. Only those portions of these patents necessary to facilitate an understanding of the manner in which an electric field can be used to alter the curvature of the convex lens surfaces are incorporated herein by reference.

Because the position of the focal point F can be controlled by varying the respective curvatures of the respective convex lens surfaces 48, 58, the concepts of the present invention are well suited for applications where it is necessary or advantageous to compensate for mechanical misalignment in opto-mechanical packages. For example, and not by way of limitation, as is illustrated schematically in FIG. 1, the tunable lens 30 can be configured to align light propagating from an output channel of the laser chip 10 with an input channel of the wavelength conversion device 20. The tunable lens 30 may be controlled to correct for misalignment in the assembly of a device or to compensate for misalignment that develops in a device over time.

Regarding the structure of the respective fluid reservoirs 42, 52 illustrated in FIG. 2, it is noted that the first and second fluid reservoirs 42, 52 comprise V-groove reservoirs, each of which is configured such that the first and second sets of control electrodes 46, 56 are symmetric relative to a vertical plane bisecting the reservoirs 42, 52. In the illustrated embodiment, the closed end of each of the V-groove reservoirs 42, 52 includes a lower, additional reservoir portion defined between the lower, substantially parallel, vertical side walls of each reservoir 42, 52. It is contemplated that the angled walls of the V-groove reservoirs 42, 52 need not terminate at the lower vertical side walls illustrated in FIG. 2. Rather, the angled walls may extend all the way to the closed end of the V-groove. In either case, the first and second sets of control electrodes 46, 56 are positioned along respective portions of the V-groove such that a degree to which the electrically responsive lens fluid interfaces with the V-groove reservoir is a function of the control voltage applied to the control electrodes 46, 56. In this manner, the curvature of the respective convex lens surfaces 48, 58 can be controlled as a function of the control voltage.

It is contemplated that fluid-containing or other supporting structure at the ends of each V-groove reservoir 42, 52 will cause some degree of non-uniformity in the convex lens surfaces 48, 58 near this supporting structure. Further, electric field irregularities near the ends of the control electrodes 46, 56 may also cause an additional degree of non-uniformity in the convex lens surfaces 48, 58 near the ends of each V-groove reservoir 42, 52. Accordingly, in practicing the present invention, it may be preferable to design the reservoirs 42, 52 such that the respective longitudinal dimensions of the reservoirs 42, 52 are sufficiently large to ensure that any discontinuities or irregularities present in the convex lens surfaces 48, 58 are well outside of the intended optical path through the lens 30.

Although the present invention has been described primarily in the context of V-groove reservoirs 42, 52, it is contemplated that the first and second fluid reservoirs may be provided in a variety of configurations. For example, it is noted that alternative reservoir profiles may yield a more linear response to variations in control voltage or may be more or less optimal in terms of the optical parameter to be tuned by the lens 30. In other circumstances, it may be preferable to achieve non-linear or exponential responses to variations in the control voltage. Contemplated profiles include, but are not limited to, the above-described V-groove profile, hyperbolic profiles, parabolic profiles, cubic profiles, circular profiles, rectangular profiles, or other linear, non-linear profiles, including combinations thereof. Thus, the electrodes may have flat, parabolic, cubic, or other cross-sectional profiles, including combinations thereof, and slight variations therefrom, the cross-section taken perpendicular to the longitudinal axis. In some embodiments, the flat, parabolic, cubic, etc., shaped surface of the electrode that contacts fluid conforms to the shape of the reservoir walls.

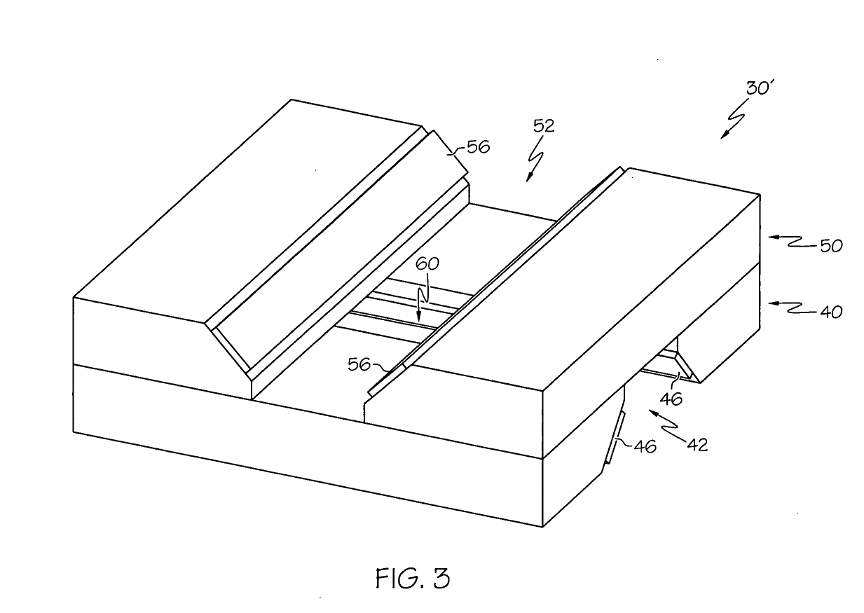

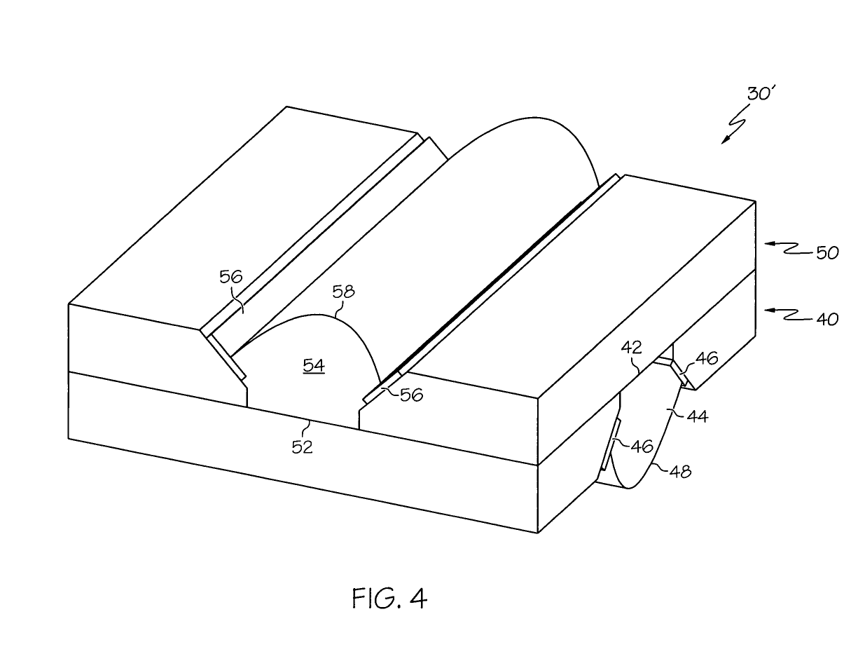

In the embodiment illustrated in FIGS. 3 and 4, where like structure is indicated with like reference numerals, an alternative tunable lens 30′ is provided where the first lens component 40 is inverted relative to the second lens component 50. By inverting the first lens component 40 in the illustrated manner, the first and second convex lens surfaces 48, 58 provide a bi-convex lens configuration, i.e. the convex lens surfaces 48, 58 face away from each other. In addition, the first and second lens components 40, 50 are arranged such that the respective fluid reservoirs 42, 52 communicate via a common fluid aperture 60 provided between the lens components 40, 50. Although not illustrated in FIGS. 3 and 4, the fluid aperture may optionally be covered by a transparent membrane if there is a need to isolate the fluids within each lens component.

For the convenience of illustration, specific structural portions of the lens components 40, 50 forming the fluid reservoirs 42, 52 have been omitted from FIGS. 2-4. Specifically, as will be appreciated by those practicing the present invention, each fluid reservoir 42, 52 may preferably be provided with respective end faces and cover plates to help contain the lens fluids 44, 54. Where cover plates or other structure is provided to help contain the lens fluids 44, 54, it is contemplated that such structure should be selected to complement the optical properties of the system and introduce minimal optical degradation along the axis of optical propagation 35. For example, cover plates may be provided to serve as collimating lenses, focusing lenses, polarizing components, diffraction components, etc.

Further, a complementary but distinct fluid may be provided within one or both of the lens components 40, 50 to help stabilize and facilitate proper control of the lens fluids 44, 54. For example, and not by way of limitation, where an electrically responsive oil is used as the lens fluid, an aqueous-based fluid may be encased within the lens component and disposed over the oil held within the fluid reservoir of the lens. This type of configuration is illustrated clearly in the above-noted U.S. patents and these teachings may be readily applied in practicing particular concepts of the present invention.

It is noted that, where two distinct fluids are provided in the fluid reservoir, either of the two fluids may function as the electrically responsive fluid. For example, referring to the embodiment of the present invention illustrated in FIG. 2, we have described the case where a substantially non-responsive, aqueous-based fluid is encased within the lens component 40, 50 and disposed over an electrically responsive fluid 44, 54 held within the fluid reservoir 42, 52. Alternatively, the fluid 44, 54 illustrated in FIG. 2 may be a non-responsive fluid, if an electrically responsive complementary fluid is disposed over the non-responsive fluid. In addition, it is also contemplated that both of the fluids provided in each lens component 40, 50 can be selected to be electrically responsive.

The concepts of the present invention have been illustrated above with reference to the use of electrically responsive lens fluids and respective sets of control electrodes. However, it is also contemplated that the first and second lens fluids may comprise a pressure sensitive lens fluid where the curvature of the convex lens surfaces can be controlled by controlling the supply of fluid to the respective fluid reservoirs. The first and second fluid supplies can be distinct fluid supplies or a common fluid supply. The use of pressure sensitive lens fluids within liquid lenses is taught with more particularity in U.S. Pat. Nos. 5,438,486 and 6,188,526, the disclosures of which are incorporated herein by reference.

It is noted that terms like “preferably,” “commonly,” and “typically,” if utilized herein, are not used to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue. The term “substantially” is further utilized herein to represent a minimum degree to which a quantitative representation must vary from a stated reference to yield the recited functionality of the subject matter at issue.

Having described the invention in detail and by reference to specific embodiments thereof, it will be apparent that modifications and variations are possible without departing from the scope of the invention defined in the appended claims. More specifically, although some aspects of the present invention may be identified herein as preferred or particularly advantageous, it is contemplated that the present invention is not necessarily limited to these aspects of the invention.

What is claimed is:

1. A semiconductor laser comprising a laser chip, a light wavelength conversion device, and a tunable lens comprising first and second fluid lens components positioned to direct light from said laser chip to said light wavelength conversion device, wherein:
said first fluid lens component comprises a first fluid reservoir, a first electrically responsive lens fluid, and a first set of control electrodes;
said first electrically responsive lens fluid is positioned within said first fluid reservoir in a generally longitudinal configuration and comprises a first lens surface that is oriented substantially parallel to a first longitudinal tuning axis of said tunable lens;
said first set of control electrodes are oriented substantially parallel to said first longitudinal tuning axis of said tunable lens and are positioned to generate an electric field capable of altering the curvature of said first lens surface;
said second fluid lens component comprises a second fluid reservoir, a second electrically responsive lens fluid, and a second set of control electrodes;
said second electrically responsive lens fluid is positioned within said second fluid reservoir in a generally longitudinal configuration and comprises a second lens surface that is oriented substantially parallel to a second longitudinal tuning axis of said tunable lens;
said second set of control electrodes are oriented substantially parallel to said second longitudinal tuning axis of said tunable lens and are positioned to generate an electric field capable of altering the curvature of said second lens surface; and
said first and second fluid lens components are oriented such that said first and second longitudinal tuning axes are skewed relative to each other about an axis of optical propagation of light directed from said laser chip to said light wavelength conversion device.

2. The semiconductor laser of claim 1 wherein said curvature of one or both of said first and second lens surfaces forms a substantially cylindrical profile or a skewed substantially cylindrical profile.

3. The semiconductor laser of claim 2 wherein said respective profiles of said first and second convex lens surfaces approximate a circular or non-circular cylinder.

4. The semiconductor laser of claim 2 wherein said respective profiles of said first and second convex lens surfaces approximate a circular or non-circular cylinder comprising flat or nearly flat surface portions in their respective cross sections.

5. The semiconductor laser of claim 1 wherein said curvature of one or both of said first and second lens surfaces is convex.

6. The semiconductor laser of claim 1 wherein said curvature of one or both of said first and second lens surfaces is concave.

7. The semiconductor laser of claim 1 wherein:
said first fluid reservoir comprises a first pair of longitudinal container walls disposed on opposite sides of an intersecting plane passing through said first longitudinal tuning axis, parallel to said axis of optical propagation; and
said second fluid reservoir comprises a second pair of longitudinal container walls disposed on opposite sides of an intersecting plane passing through said second longitudinal tuning axis, parallel to said axis of optical propagation.

8. The semiconductor laser of claim 7 wherein:
said first set of control electrodes are disposed along or extend generally parallel to said first pair of longitudinal container walls; and
said second set of control electrodes are disposed along or extend generally parallel to said second pair of longitudinal container walls.

9. The semiconductor laser of claim 7 wherein:
said first fluid reservoir, said first electrically responsive lens fluid, and said first set of control electrodes are configured such that a degree of symmetry of said first lens surface, relative to said intersecting plane, is a function of a control voltage applied to said first set of control electrodes; and
said second fluid reservoir, said second electrically responsive lens fluid, and said second set of control electrodes are configured such that a degree of symmetry of said second lens surface, relative to said intersecting plane, is a function of a control voltage applied to said second set of control electrodes.

10. The semiconductor laser of claim 1 wherein said first and second lens components are arranged such that the respective fluid reservoirs communicate via a common fluid aperture provided in each lens component.

11. The semiconductor laser of claim 1 wherein said tunable lens further comprises collimating optics configured such that light directed from said laser chip to said tunable lens and from said tunable lens to said wavelength conversion device is substantially collimated.

12. The semiconductor laser of claim 1 wherein said first lens component is inverted relative to said second lens component.

13. The semiconductor laser of claim 1 wherein said first and second sets of control electrodes each comprise at least two substantially parallel electrodes spaced from each other across at least a portion of said first and second lens fluids, respectively.

14. The semiconductor laser of claim 13 wherein said first and second sets of control electrodes are disposed along or extending generally parallel to opposing walls of said first and second fluid reservoirs, respectively.

15. The semiconductor laser of claim 1 wherein at least one of said first and second sets of control electrodes has a cross-sectional profile, taken perpendicular to a respective longitudinal tuning axis, the profile being selected from the group consisting of flat, parabolic, and cubic profiles, including combinations thereof.

16. The semiconductor laser of claim 1 wherein said tunable lens is configured to align light propagating from an output channel of said laser chip with an input channel of said wavelength conversion device.

17. A semiconductor laser comprising a laser chip, a light wavelength conversion device, and a tunable lens comprising first and second fluid lens components positioned to direct light from said laser chip to said light wavelength conversion device, wherein:
said first fluid lens component comprises a first fluid reservoir, and a first electrically responsive or pressure sensitive lens fluid;
said first lens fluid is positioned within said first fluid reservoir in a generally longitudinal configuration and comprises a first lens surface that is oriented substantially parallel to a first longitudinal tuning axis of said tunable lens;
said tunable lens is configured to permit controlled alteration of the curvature of said first lens surface;
said second fluid lens component comprises a second fluid reservoir, and a second electrically responsive or pressure sensitive lens fluid;
said second lens fluid is positioned within said second fluid reservoir in a generally longitudinal configuration and comprises a second lens surface that is oriented substantially parallel to a second longitudinal tuning axis of said tunable lens;
said tunable lens is configured to permit controlled alteration of the curvature of said second lens surface; and
said first and second fluid lens components are oriented such that said first and second longitudinal tuning axes are skewed relative to each other about an axis of optical propagation of light directed from said laser chip to said light wavelength conversion device.

18. The semiconductor laser of claim 17 wherein:
said first lens fluid comprises an electrically responsive lens fluid;
said first fluid lens component further comprises a first set of control electrodes oriented substantially parallel to said first longitudinal tuning axis of said tunable lens and are positioned to generate an electric field capable of altering the curvature of said first lens surface.
said second lens fluid comprises an electrically responsive lens fluid; and
said second fluid lens component further comprises a second set of control electrodes oriented substantially parallel to said second longitudinal tuning axis of said tunable lens and are positioned to generate an electric field capable of altering the curvature of said second lens surface.

19. The semiconductor laser of claim 17 wherein:
said first lens fluid comprises a pressure sensitive lens fluid;
said first fluid lens component further comprises a fluid supply configured to control an amount of fluid in said first lens fluid to alter the curvature of said first lens surface;
said second lens fluid comprises a pressure sensitive lens fluid; and
said second fluid lens component further comprises a fluid supply configured to control an amount of fluid in said second lens fluid to alter the curvature of said second lens surface.

20. A tunable lens comprising first and second fluid lens components positioned to direct light along a common axis of optical propagation, wherein:
said first fluid lens component comprises a first fluid reservoir, and a first electrically responsive or pressure sensitive lens fluid;
said first lens fluid is positioned within said first fluid reservoir in a generally longitudinal configuration and comprises a first lens surface that is oriented substantially parallel to a first longitudinal tuning axis of said tunable lens;
said tunable lens is configured to permit controlled alteration of the curvature of said first lens surface;
said second fluid lens component comprises a second fluid reservoir, and a second electrically responsive or pressure sensitive lens fluid;
said second lens fluid is positioned within said second fluid reservoir in a generally longitudinal configuration and comprises a second lens surface that is oriented substantially parallel to a second longitudinal tuning axis of said tunable lens;
said tunable lens is configured to permit controlled alteration of the curvature of said second lens surface; and
said first and second fluid lens components are oriented such that said first and second longitudinal tuning axes are skewed relative to each other about said axis of optical propagation.

21. An optical system comprising the tunable lens of claim 20, a first optical component defining an output channel, and a second optical component defining an input channel, wherein said tunable lens is configured to align light propagating from said output channel of said first optical component with an input channel of said second optical component.
